(19) United States
(12) Patent Application Publication
(10) Pub. No.: US 2020/0311771 A1
(43) Pub. Date: Oct. 1, 2020

(54) INFORMATION PROCESSING DEVICE, INFORMATION PROCESSING METHOD, AND PROGRAM RECORDING MEDIUM

(71) Applicant: NEC Corporation, Tokyo (JP)

(72) Inventors: Chisato OKAWA, Tokyo (JP); Yoshiaki HIROTANI, Tokyo (JP)

(73) Assignee: NEC Corporation, Tokyo (JP)

(21) Appl. No.: 16/828,503

(22) Filed: Mar. 24, 2020

(30) Foreign Application Priority Data
Mar. 26, 2019 (JP) 2019-059074

(51) Int. Cl. G06Q 30/02; G09F 9/00

(52) U.S. Cl. CPC G06Q 30/0264; G06Q 30/0246; G06F 3/1423; G06Q 30/0254; G09F 9/00; G06Q 30/0244

(57) ABSTRACT

An information processing device according to one aspect of the present disclosure includes: at least one memory storing a set of instructions; and at least one processor configured to execute the instructions to: generate viewing data relating to viewing of a content to be output according to an output schedule; determine whether to change the output schedule, based on the viewing data of which a predetermined value relating to the generated viewing data does not satisfy a predetermined target value; and change the output schedule, based on a result of the determination, in such a way that a predetermined value relating to the viewing data satisfies the predetermined target value.

This application is based upon and claims the benefit of priority from Japanese Patent Application No. 2019-059074, filed on Mar. 26, 2019, the disclosure of which is incorporated herein in its entirety by reference.

### TECHNICAL FIELD

The present disclosure relates to a device, a method, and a program recording medium that control a schedule of outputting a content.

### BACKGROUND ART

In a store, a public facility, or the like, a system that performs information transmission by use of electronic equipment called a digital signage is used.

In the digital signage, switching of contents to be output is performed based on a statically determined schedule. In recent years, in order to improve an advertising effect by a content, there is known a method of imaging a certain range by use of an imaging device, dynamically determining a schedule, based on information on a person located in the certain range, and switching contents. For example, there is a method of extracting an attribute of an imaged person, and outputting a content predicted to be high in an advertising effect, based on the extracted attribute of the person.

PTL 1 (Japanese Unexamined Patent Application Publication No. 2013-140196) discloses a digital signage terminal that can display an appropriate content relevant to a group of viewers. A technique disclosed in PTL 1 previously stores data associating a group with a content. Then, the technique extracts attributes (a sex, an age, and the like) of a plurality of persons captured by use of an imaging device, classifies the plurality of persons into a group, based on the extracted attributes, and outputs a content associated with the classified group.

Incidentally, in order to select an appropriate content, based on an attribute of a person, viewing data relating to viewing of a content may be acquired.

In order to select an appropriate content, based on viewing data, it is preferable to acquire abundant unbiased viewing data. However, depending on an acquisition environment of viewing data, the viewing data may not be collected as planned.

PTL 1 does not disclose acquisition of viewing data.

### SUMMARY

The present disclosure has been made in view of the problem described above, and a main object thereof is to provide an information processing device and the like that acquire desired data to be used for selection of an appropriate content.

The present disclosure provides an advantageous effect that desired data to be used for selection of an appropriate content can be collected.

An information processing device according to one aspect of the present disclosure includes: at least one memory storing a set of instructions; and at least one processor configured to execute the instructions to: generate viewing data relating to viewing of a content to be output according to an output schedule; determine whether to change the output schedule, based on the viewing data of which a predetermined value relating to the generated viewing data does not satisfy a predetermined target value; and change the output schedule, based on a result of the determination, in such a way that a predetermined value relating to the viewing data satisfies the predetermined target value.

An information processing method according to one aspect of the present disclosure includes: generating viewing data relating to viewing of a content to be output according to an output schedule; determining whether to change the output schedule, based on the viewing data of which a predetermined value relating to the generated viewing data does not satisfy a predetermined target value; and changing the output schedule, based on a result of the determination, in such a way that a predetermined value relating to the viewing data satisfies the predetermined target value.

A program according to one aspect of the present disclosure causes a computer to execute: processing of generating viewing data relating to viewing of a content to be output according to an output schedule; processing of determining whether to change the output schedule, based on the viewing data of which a predetermined value relating to the generated viewing data does not satisfy a predetermined target value; and processing of changing the output schedule, based on a result of the determination, in such a way that a predetermined value relating to the viewing data satisfies the predetermined target value.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating one example of a hardware configuration of a computer that implements an information processing device and a contents control device in each example embodiment;

FIG. 2 is a diagram schematically illustrating one example of a configuration of a contents control system according to a first example embodiment;

FIG. 3 is a block diagram illustrating one example of a functional configuration of a contents control system according to the first example embodiment;

FIG. 4 is a diagram illustrating one example of set information of a prediction model according to the first example embodiment;

FIG. 5 is a diagram illustrating one example of an acquisition pattern according to the first example embodiment;

FIG. 6 is a diagram illustrating one example of an output schedule according to the first example embodiment;

FIG. 7 is a block diagram illustrating one example of a functional configuration of a viewing data generation unit according to the first example embodiment;

FIG. 8 is a block diagram illustrating one example of a functional configuration of a determination unit according to the first example embodiment;

FIG. 9 is a flowchart illustrating an operation of a schedule generation unit according to the first example embodiment;

FIG. 10 is a flowchart illustrating an operation of a contents selection unit according to the first example embodiment;

FIG. 11 is a flowchart illustrating an operation of the viewing data generation unit according to the first example embodiment;

FIG. 12 is a diagram illustrating one example of measurement data according to the first example embodiment;

FIG. 13 is a diagram illustrating one example of viewing data according to the first example embodiment;

FIG. 14 is a diagram illustrating one example of operations of the determination unit and a schedule change unit according to the first example embodiment;

FIG. 15 is a diagram illustrating one example of an output schedule after changed according to the first example embodiment;

FIG. 16 is a diagram illustrating one example of an output schedule after changed according to the first example embodiment;

FIG. 17 is a diagram illustrating one example of an operation of a prediction model generation unit according to the first example embodiment;

FIG. 18 is a block diagram illustrating one example of a determination unit according to a second example embodiment;

FIG. 19 is a diagram illustrating one example of set information of a prediction model according to the second example embodiment;

FIG. 20 is a diagram illustrating one example of operations of the determination unit and a schedule change unit according to the second example embodiment;

FIG. 21 is a block diagram illustrating one example of a minimum configuration of an information processing device according to a third example embodiment; and

FIG. 22 is a flowchart illustrating an operation of the information processing device according to the third example embodiment.

### EXAMPLE EMBODIMENT

Configuration Example of Hardware According to Each Example Embodiment

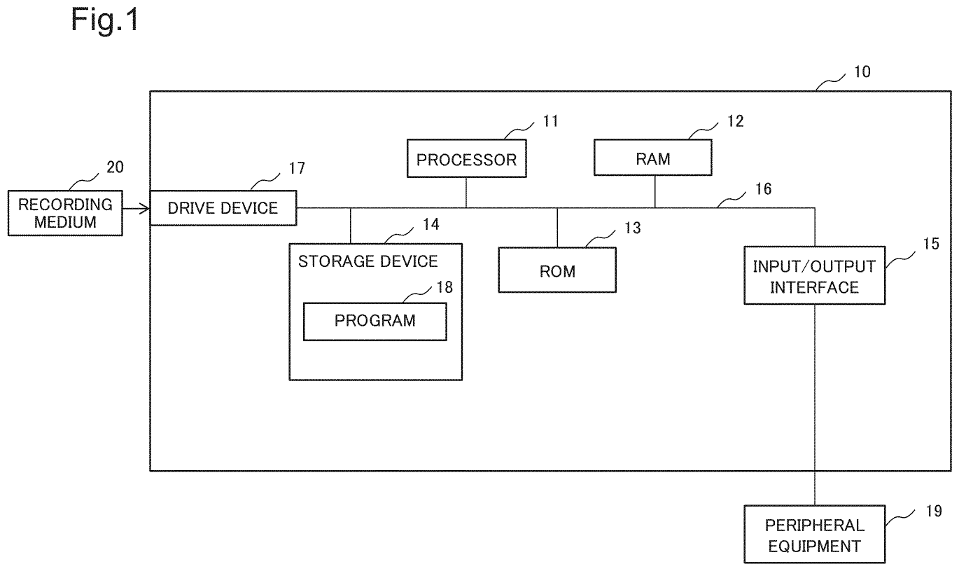

One example of hardware configuring an information processing device and a contents control device according to each example embodiment is described. FIG. 1 is a block diagram illustrating one example of a hardware configuration of a computer that implements the information processing device and the contents control device according to each example embodiment. Each block illustrated in FIG. 1 can be achieved by any combination of a computer 10 that implements each of an information processing device, an information processing method, and a contents control device according to each example embodiment, and software.

As illustrated in FIG. 1, the computer 10 includes one or a plurality of processors 11, a random access memory (RAM) 12, a read only memory (ROM) 13, a storage device 14, an input/output interface 15, and a bus 16.

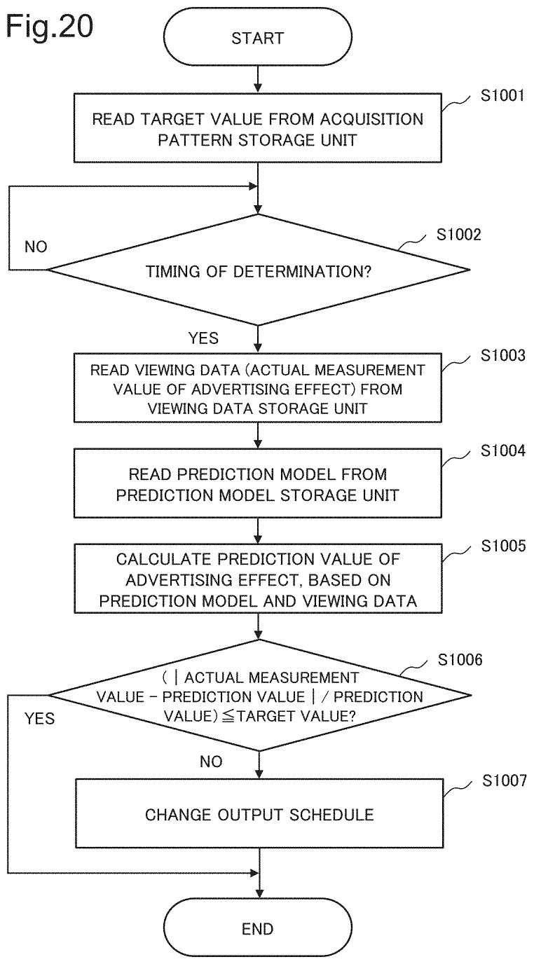

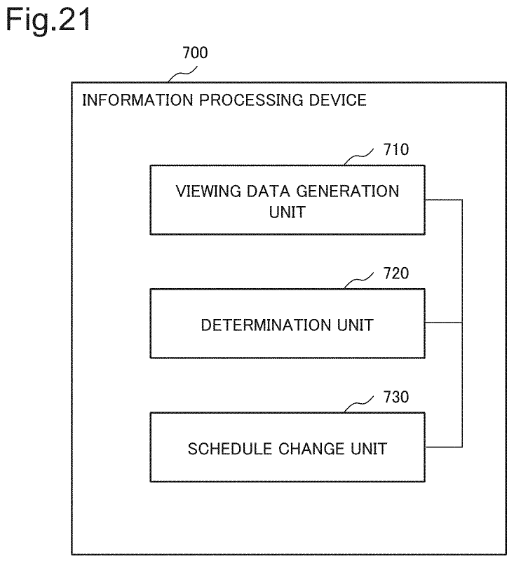

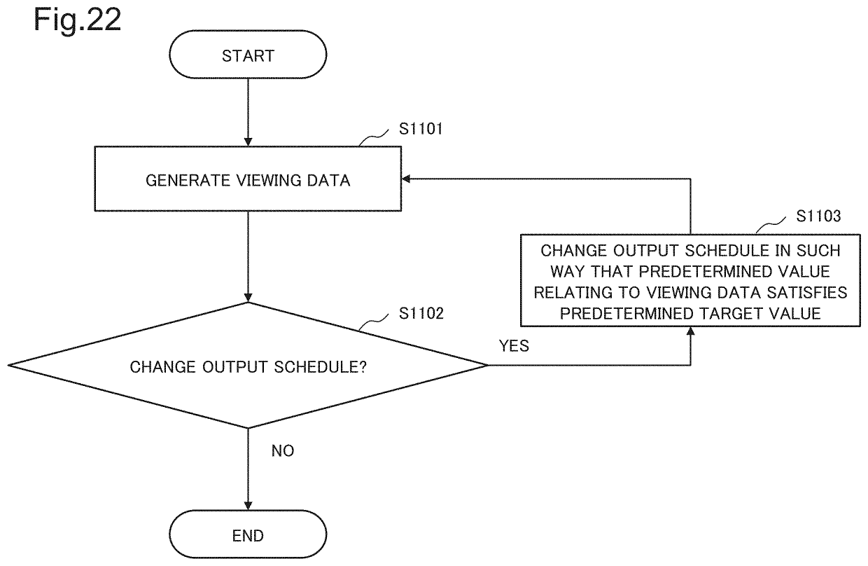

The storage device 14 stores a program 18. The processor 11 executes the program 18 related to the present information processing device and the present contents control device by use of the RAM 12. Specifically, for example, the program 18 includes a program that causes a computer to execute processing illustrated in FIGS. 9, 10, 11, 14, and 17, or processing illustrated in FIGS. 20 and 22. The processor 11 executes the program 18, and thereby implements a function of each component (a schedule generation unit 110, an acquisition unit 120, a contents selection unit 130, and an analysis unit 140 described later) except for the information processing device, out of each component (a viewing data generation unit 510, a determination unit 520, and a schedule change unit 530 described later) of the present information processing device and the present contents control device. The program 18 may be stored in the ROM 13. Moreover, the program 18 may be recorded in a recording medium 20, and read by a drive device 17, or may be transmitted from an external device via a network.

The input/output interface 15 exchanges data with peripheral equipment (a keyboard, a mouse, a display device, or the like) 19. The input/output interface 15 acquires or outputs data. The bus 16 connects each component.

Note that there are various modification examples of implementation method for the information processing device and the contents control device. For example, the information processing device and the contents control device can be each implemented as a dedicated device. Moreover, the information processing device can be implemented as a dedicated device being different from the contents control device and being communicable with the contents control device. Further, the information processing device and the contents control device can be each implemented by a combination of a plurality of devices.

The scope of each example embodiment also covers a processing method of recording, in a recording medium, a program that implements each component in a function of each example embodiment, reading, as a code, the program recoded in the recording medium, and executing the program in a computer. In other words, the scope of each example embodiment also covers a computer-readable recording medium. Moreover, each example embodiment also covers not only a recording medium recording the program described above, but also the program itself.

As the recording medium, for example, a floppy (registered trademark) disc, a hard disk, an optical disc, a magnet-optical disc, a compact disc (CD)-ROM, a magnetic tape, a non-volatile memory card, or a ROM can be used. Moreover, the scope of each example embodiment is not limited to execution of processing with a single program recorded in the recording medium, and also covers execution of processing by operating on an operating system (OS) in cooperation with another piece of software and a function of an expansion board.

### First Example Embodiment

Next, an overview of each component in a contents control system configuring digital signage is described.

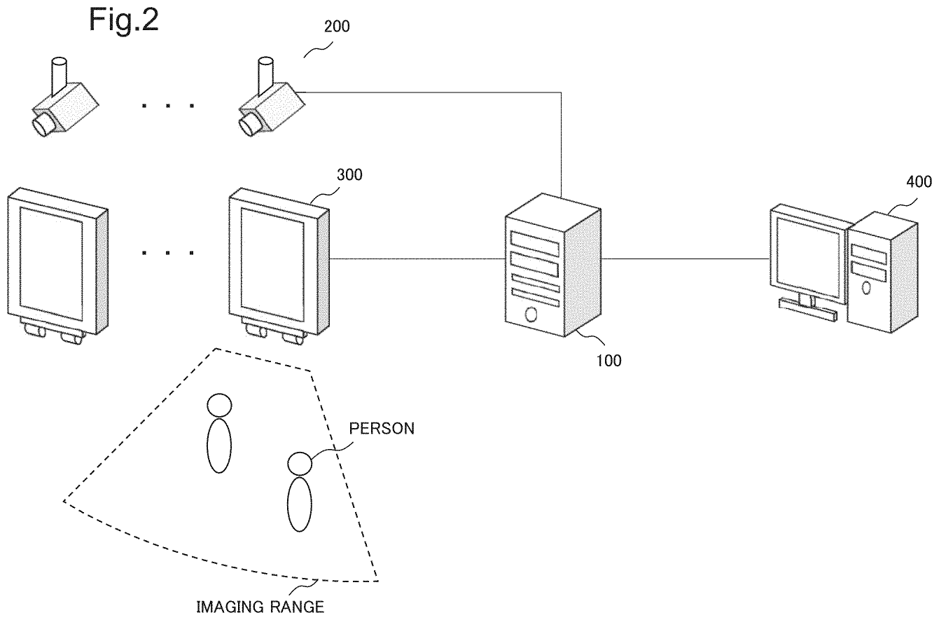

FIG. 2 is a diagram schematically illustrating one example of a configuration of a contents control system according to the first example embodiment. As illustrated in FIG. 2, the contents control system includes a contents control device 100, an imaging device 200, an output device 300, and a management terminal 400. The contents control system is a system that causes the output device 300 to output a content, based on control of at least the contents control device 100.

The contents control device 100 is connected to the imaging device 200, the output device 300, and the management terminal 400 communicably with one another. Herein, the contents control device 100 may be connected to a plurality of imaging devices 200 and a plurality of output devices 300.

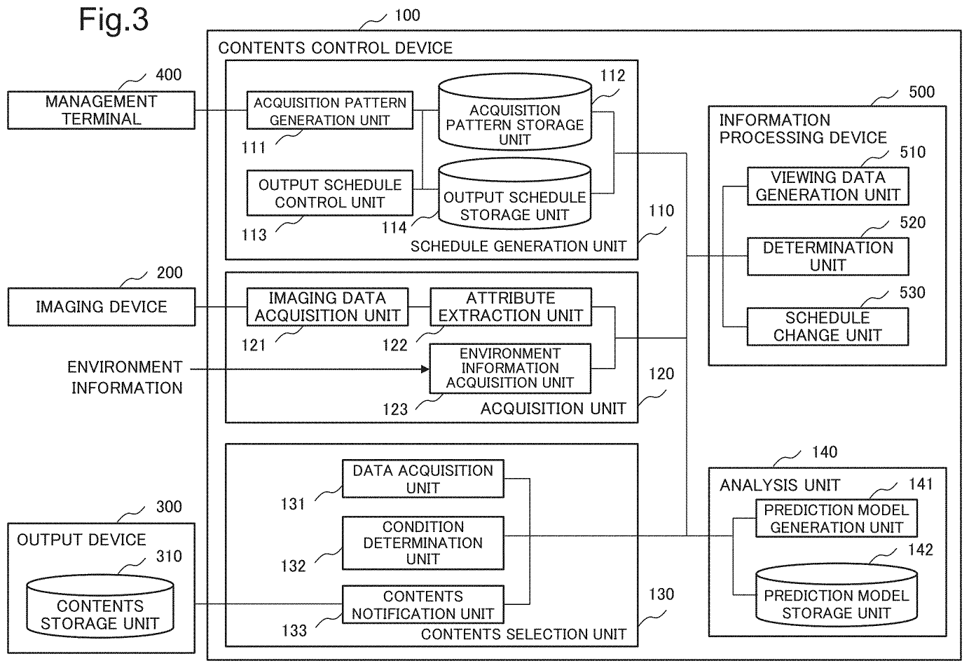

FIG. 3 is a block diagram illustrating one example of a functional configuration of the contents control system illustrated in FIG. 2. Each block in the contents control device 100 illustrated in FIG. 3 may be mounted in a single device, or may be mounted separately in a plurality of devices. Transmission and reception of data between blocks may be performed via any means such as a data bus, a network, a portable storage medium, or the like.

As illustrated in FIG. 3, the contents control device 100 includes an information processing device 500. Moreover, the contents control device 100 includes a schedule generation unit 110, an acquisition unit 120, a contents selection unit 130, and an analysis unit 140. The contents control device 100 has a function of selecting, based on information acquired from the imaging device 200 and the management terminal 400, a content to be output to the output device 300. Moreover, the contents control device 100 has a function of generating, based on viewing data relating to a selected content, a prediction model for predicting an advertising effect of the content. An example in which the information processing device 500 is included in the contents control device 100 is described below, but the information processing device 500 is not limited to this example. For example, the information processing device 500 may be an independent device communicably connected to the contents control device 100.

The imaging device 200 images a predetermined range. The range to be imaged by the imaging device 200 is referred to as an “imaging range”. It is assumed, in FIG. 2, that a range indicated by a dotted line located on a front side of the output device 300 is the imaging range. For example, the imaging range may be a range in front of the output device 300 and within a radius of 5 meters from a central point of a place where the output device 300 is disposed, or may be a range of 5 square meters in front of the output device 300. Further, it is assumed that a person located within the imaging range is able to view a content output by the output device 300. The imaging device 200 images the imaging range, and transmits generated imaging data to the contents control device 100.

The output device 300 is, for example, a signage terminal that displays a content such as a video image or a character by a flat display or a projector. As illustrated in FIG. 3, the output device 300 includes a contents storage unit 310. The contents storage unit 310 includes at least actual data of contents. The output device 300 reads, from the contents storage unit 310, a content selected by the contents control device 100, and outputs the read content. Note that the present example embodiment adopts, as a scheme of moving image distribution to the output device 300, a storage and playback type that prestores and then playbacks a content, but a streaming type that receives a content by streaming distribution and playbacks and outputs the content may be adopted.

Herein, when a plurality of imaging devices 200 and a plurality of output devices 300 exist, the imaging range of each of the output devices 300 is imaged by at least one imaging device 200.

The management terminal 400 is a device including an input/output unit for managing the contents control system. The management terminal 400 may be, for example, a personal computer. The management terminal 400 transmits, to the contents control device 100, a prediction model, and information for generating an output schedule (details thereof will be described later) of a content to be selected by the contents control device 100.

The contents control device 100, the imaging device 200, the output device 300, and the management terminal 400 are each illustrated as an independent device in FIGS. 2 and 3, but are not limited to this. In other words, for example, the contents control device 100 may be included in the output device 300. Moreover, the contents control device 100 may be included in a device in which the imaging device 200, the output device 300, and the management terminal 400 are integrated. Further, the contents control device 100 may be built in an on-premise environment, or may be built in a cloud environment.

Next, an overview of each component of the contents control device 100 is described.

The schedule generation unit 110 includes an acquisition pattern generation unit 111, an acquisition pattern storage unit 112, an output schedule control unit 113, and an output schedule storage unit 114. The schedule generation unit 110 generates an output schedule, based on information acquired from the management terminal 400.

The acquisition unit 120 includes an imaging data acquisition unit 121, an attribute extraction unit 122, and an environment information acquisition unit 123. The acquisition unit 120 extracts information relating to a person, i.e., measurement data relating to a person, by use of imaging data acquired from the imaging device 200. Moreover, the acquisition unit 120 acquires environment information from a non-illustrated communicably connected external device or the like. Note that the acquisition unit 120 may be included in the imaging device 200, or may be included in a non-illustrated external device communicably connected to the imaging device 200 and the contents control device 100.

The contents selection unit 130 includes a data acquisition unit 131, a condition determination unit 132, and a contents notification unit 133. The contents selection unit 130 reads an output schedule from the schedule generation unit 110, and selects, according to the read output schedule, a content to be output to the output device 300.

The analysis unit 140 includes a prediction model generation unit 141 and a prediction model storage unit 142. The analysis unit 140 generates a prediction model for predicting an advertising effect of a content. Note that the analysis unit 140 may be included in a non-illustrated external device communicably connected to the contents control device 100.

The information processing device 500 includes a viewing data generation unit 510, a determination unit 520, and a schedule change unit 530. The information processing device 500 generates viewing data relating to a content output by the output device 300, performs a predetermined determination relating to the generated viewing data, and changes an output schedule, based on a result of the determination result. Herein, the viewing data are data generated based on measurement data relating to a person from the acquisition unit 120, and are information relating to a person viewing a content. Moreover, for example, when a content is output, viewing data may include information relating to a person located around a digital signage terminal. The viewing data are generated for each of contents to be output by the output device 300 (details will be described later).

Next, details of a component of each of the schedule generation unit 110, the acquisition unit 120, the contents selection unit 130, and the analysis unit 140 are described.

Details of Schedule Generation Unit 110

Details of each component of the schedule generation unit 110 are described. The acquisition pattern generation unit 111 acquires, from the management terminal 400, information (hereinafter, also referred to as “set information of a prediction model”) relating to an objective variable and an explanatory variable for generating a prediction model. The set information of a prediction model is information designated by a manager or a user (hereinafter, also simply referred to as a “manager”) of the contents control system.

The objective variable is, for example, an index representing an advertising effect of a content. Herein, an index representing an advertising effect of a content is, for example, a viewing amount and an audience rating. The viewing amount may be a number of persons viewing a content while the output device 300 is outputting the content, or may be a total of stay time in an imaging range of a person viewing the content. The audience rating may be a ratio of persons viewing a content among persons located in an imaging range while the output device 300 is outputting the content. Alternatively, the audience rating may be a total of stay time of a person viewing the content among totals of stay time of persons located in an imaging range.

The explanatory variable is set to, for example, an attribute of a person, and environment information.

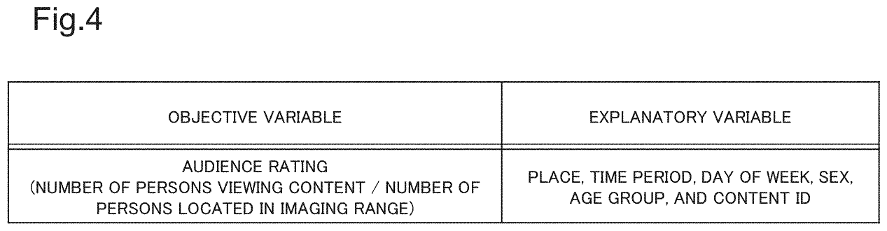

FIG. 4 is a diagram illustrating one example of set information of a prediction model. In the example of FIG. 4, the objective variable is set to {audience rating}, and the explanatory variable is set to each of items {place}, {time}, {day of the week}, {sex}, {age group}, and {content identification (ID)}. Herein, the content ID is information with which a content is identified.

The acquisition pattern generation unit 111 generates an acquisition pattern on the basis of the set information of the prediction model. The acquisition pattern is a pattern of data that a manager desires to acquire, and is one or more patterns designated by at least one value among values to which environment information or information relating to a person belongs. For example, the acquisition pattern may be a data set generated on the basis of a combination of items designated as explanatory variables.

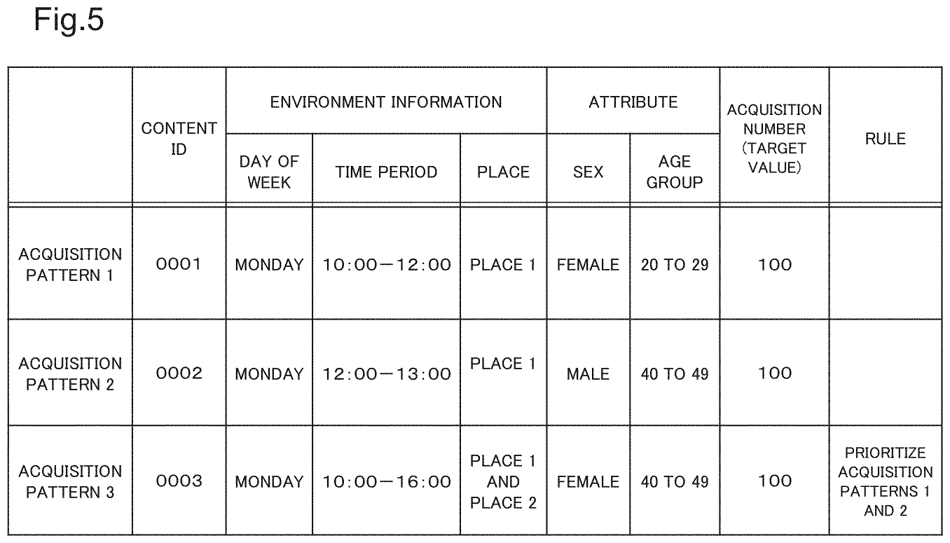

FIG. 5 is a diagram illustrating one example of the acquisition pattern. The acquisition pattern is configured by a set of data for a plurality of items. In FIG. 5, three acquisition patterns, i.e., acquisition patterns 1, 2, and 3 are illustrated. For example, the acquisition pattern 1 has each value set as follows: {0001} to a content ID, {Monday} to a day of the week, {10:00 to 12:00} to a time period, {place 1} to a place, {female} to a sex, and {20 to 29} to an age group. This means that, when a person who has attributes being a sex of {female} and an age group of {20 to 29} is detected in an environment where a day is {Monday}, a time period is {10:00 to 12:00}, and a place is {place 1}, a content with a content ID being {0001} is output, and measurement data are acquired. In this instance, the measurement data are information relating to a person located in an imaging range while the content is being output. In other words, acquiring the measurement data indicates acquiring, from imaging data acquired by the imaging device 200, information relating to a person located in an imaging range while the content is being output.

Furthermore, as illustrated in FIG. 5, an “acquisition number” and a “rule” are set for each acquisition pattern. The “acquisition number” is a target value (also referred to as a “first target value”) of the number of pieces of viewing data to be generated in relation to a content output according to a schedule (details will be described later) relevant to the acquisition pattern. Herein, one piece of viewing data is generated each time a content is output. In other words, the number of pieces of the viewing data to be generated is relevant to the number of times of output of a content for each acquisition pattern. The “rule” is a rule relating to acquisition of measurement data in each acquisition pattern, and regulates, for example, a priority degree of measurement data to be acquired. In the example of FIG. 5, the acquisition pattern 3 indicates that acquisition of measurement data relevant to the acquisition pattern 1 and the acquisition pattern 2 is prioritized over acquisition of measurement data relevant to the acquisition pattern 3. Moreover, the same target value is set for all the acquisition patterns in the example of FIG. 5, but a different target value may be set for each acquisition pattern. Further, the example of FIG. 5 illustrates that the target value is set for each acquisition pattern, but one target value may be set for all the acquisition patterns.

The acquisition pattern generation unit 111 may generate the acquisition pattern by use of a value input by a manager via the management terminal 400. For example, the acquisition pattern generation unit 111 may display, on the management terminal 400, an input screen for inputting a specific value of each item configuring environment information and an attribute of a person, a content ID, a target value, and a rule. Without being limited to this example, the acquisition pattern generation unit 111 may generate the acquisition pattern by use of a random value of an item designated as the explanatory variable.

The acquisition pattern storage unit 112 stores the set information of the prediction model acquired by the acquisition pattern generation unit 111, and the generated acquisition pattern.

The output schedule control unit 113 reads the acquisition pattern from the acquisition pattern storage unit 112, and generates an output schedule, based on the read acquisition pattern. Specifically, the output schedule control unit 113 generates, for each acquisition pattern, an individual output schedule of outputting a content, based on a value of each item set to the acquisition pattern.

The individual output schedule is an output schedule for each of contents, and includes information associating a condition for outputting each of contents with information relating to the content to be output. A condition includes a value of at least one item of environment information and an attribute. Information relating to the content to be output is, for example, a content ID and an output time of a content.

Herein, a generic term of each generated individual output schedule is referred to as an output schedule. Moreover, hereinafter, in the present description, the individual output schedule is also simply referred to as a schedule. When a value of an item designated as a condition of the individual output schedule coincides with a value of environment information and an attribute acquired by the acquisition unit 120, the contents control device controls in such a way that the output device 300 outputs a content associated with the condition.

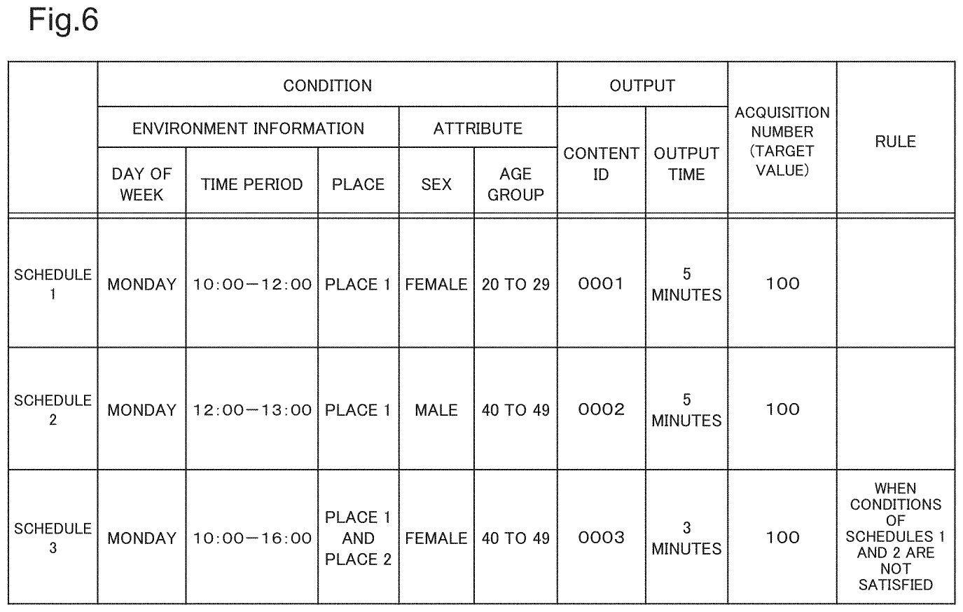

FIG. 6 is a diagram illustrating one example of the output schedule. In FIG. 6, three individual output schedules, i.e., schedules 1, 2, and 3 are illustrated. The schedules 1, 2, and 3 are relevant to the acquisition patterns 1, 2, and 3, respectively. “Output” indicates information relating to the above-described content to be output. For example, the schedule 1 indicates that a content having an output time of “5 minutes” and a content ID {0001} are output when {female} in {20 to 29} is located in an imaging range at {place 1} in a time period of {10:00 to 12:00} on {Monday}.

Furthermore, a target value and a rule are set to output schedules. These output schedules are relevant to the target value and the rule set to the acquisition pattern, respectively. The rule set to the output schedule indicates a priority degree between schedules. In the example of FIG. 6, a rule relevant to the rule set to the acquisition pattern 3 is set to the schedule 3. Herein, a priority degree between the schedules 1 and 3, and a priority degree between the schedules 2 and 3 are regulated. For example, when conditions of environment information and an attribute of the schedules 1 and 3 are satisfied, outputting preferentially a content designated in the schedule 1 is indicated.

The output schedule storage unit 114 stores the output schedule generated by the output schedule control unit 113.

As above, the schedule generation unit 110 generates an output schedule of a content, according to an acquisition pattern of designated viewing data.

Details of Acquisition Unit 120

Each component of the acquisition unit 120 is described. The imaging data acquisition unit 121 acquires imaging data from the imaging device 200. The attribute extraction unit 122 acquires measurement data relating to a person included in the imaging data. Specifically, the attribute extraction unit 122 detects a person included in the imaging data acquired by the imaging data acquisition unit 121, and also extracts an attribute of the detected person. The attribute is, but not limited to, for example, information including each of items such as a sex of a person, an age group, clothes, a height, a posture, a luggage carried by the person, and information indicating whether the person has a viewed content. The environment information acquisition unit 123 acquires environment information. The environment information is, but not limited to, for example, information including each of items being a date, a day of the week, time, a place, weather, and temperature in an imaging range. The environment information acquisition unit 123 may acquire the environment information by use of a non-illustrated sensor or a global positioning system (GPS). Further, the environment information acquisition unit 123 may acquire, as the environment information, open data acquired via a network, or a system time of each device.

Herein, when a plurality of imaging devices 200 and a plurality of output devices 300 exist, each component of the acquisition unit 120 performs the above-described processing for each piece of imaging data in an imaging range relevant to each of the output devices 300.

Details of Contents Selection Unit 130

Each component of the contents selection unit 130 is described. The contents selection unit 130 selects, according to the output schedule, a content to be output to the output device 300.

The data acquisition unit 131 reads the output schedule from the schedule generation unit 110. Moreover, the data acquisition unit 131 acquires the attribute of a person, and the environment information, from the acquisition unit 120. Based on the output schedule read by the data acquisition unit 131, the condition determination unit 132 determines whether there exists a schedule in which the acquired attribute of the person and environment information coincide with a value designated as a “condition”. In this instance, the condition determination unit 132 performs a determination by considering information regulated in a “rule” as well. When there exists a schedule in which a value of a “condition” coinciding with the acquired attribute of the person and environment information is designated, the contents notification unit 133 notifies the output device 300 and the information processing device 500 of a content ID set to “output” of the schedule.

Details of Analysis Unit 140

Each component of the analysis unit 140 is described. The prediction model generation unit 141 generates a prediction model, based on the set information of the prediction model acquired from the schedule generation unit 110, and the viewing data acquired from the viewing data generation unit 510. The prediction model storage unit 142 stores the prediction model generated by the prediction model generation unit 141.

Details of Information Processing Device 500

Next, each component of the information processing device 500 is described. The viewing data generation unit 510 generates viewing data relating to viewing of a content to be output according to the output schedule.

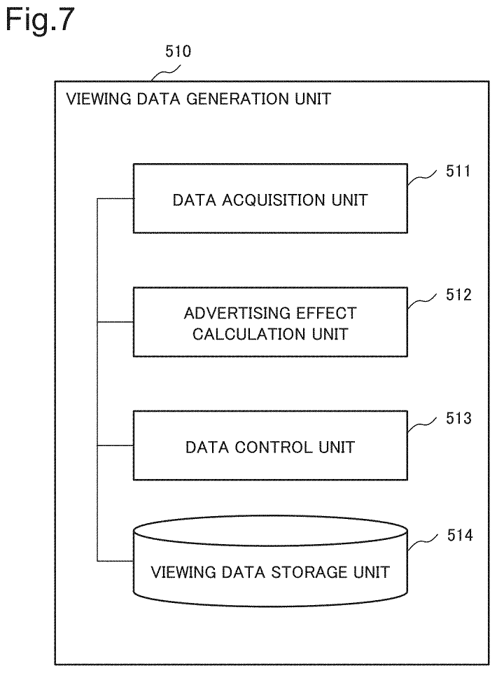

FIG. 7 is a block diagram illustrating one example of a functional configuration of the viewing data generation unit 510. The viewing data generation unit 510 includes a data acquisition unit 511, an advertising effect calculation unit 512, a data control unit 513, and a viewing data storage unit 514. The viewing data generation unit 510 generates viewing data relating to the content output by the output device 300. Herein, for example, when a content is output, the viewing data generation unit 510 measures information relating to a person located around a digital signage terminal, and an acquired advertising effect, and associates each piece of the measured information. The associated data are viewing data.

The data acquisition unit 511 receives notification of a content ID from the contents selection unit 130 described above. In response to the notification, the data acquisition unit 511 acquires, from the acquisition unit 120, measurement data relating to a person located in an imaging range of the imaging device 200 while the output device 300 is outputting the content. The advertising effect calculation unit 512 calculates an actual measurement value of an advertising effect of the content, based on the attribute of the person included in the measurement data acquired by the data acquisition unit 511. The data control unit 513 generates viewing data associating the attribute of the person acquired by the data acquisition unit 511 with the actual measurement value of the advertising effect calculated by the advertising effect calculation unit 512. Hereinafter, in the present description, an actual measurement value of an advertising effect is also simply referred to as an “actual measurement value”. The viewing data storage unit 514 stores the viewing data generated by the data control unit 513.

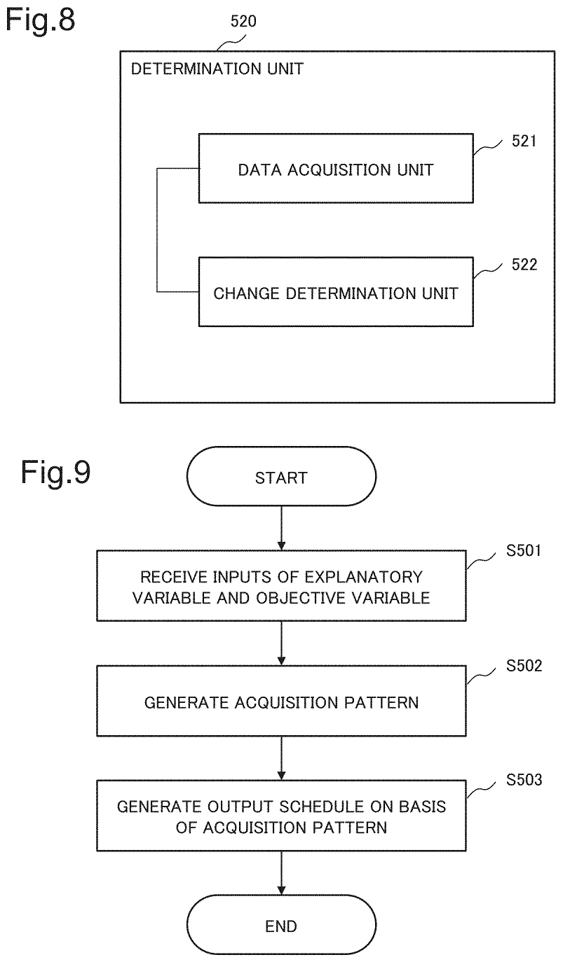

FIG. 8 is a block diagram illustrating one example of a functional configuration of the determination unit 520. The determination unit 520 determines whether to change the output schedule, based on the viewing data of which a predetermined value relating to the generated viewing data does not satisfy a predetermined target value. The determination unit 520 includes a data acquisition unit 521 and a change determination unit 522. The determination unit 520 performs a predetermined determination relating to viewing data generated based on an acquisition pattern.

Specifically, the data acquisition unit 521 reads, from the output schedule storage unit 114, a target value associated with each acquisition pattern. Moreover, the data acquisition unit 521 counts the number of pieces of viewing data generated for each acquisition pattern, and outputs a count value. The change determination unit 522 determines whether to change the output schedule, based on the target value from the data acquisition unit 521, and the number (count value) of pieces of viewing data, and outputs a determination result.

The schedule change unit 530 changes, based on the result of the determination from the determination unit 520, the output schedule stored in the output schedule storage unit 114, in such a way that a predetermined value relating to the viewing data satisfies a predetermined target value.

Operation of Contents Control System

Next, an operation of the contents control system is described. The contents control system according to the present example embodiment previously generates an output schedule, and outputs a content, based on the output schedule. Then, the contents control system generates viewing data relating to a person viewing the content, changes the output schedule, based on the number of pieces of the viewing data, and generates a prediction model, based on the viewing data. Each piece of processing is described by use of a flowchart. Hereinafter, in the present description, each step of the flowchart is expressed by use of a number given to each step, as in “S501”.

First, processing of generating an output schedule is described.

Before selecting a content to be output by the output device 300, the contents control device 100 previously generates an output schedule. The output schedule is generated by the schedule generation unit 110 in the contents control device 100.

FIG. 9 is a flowchart illustrating an operation of the schedule generation unit 110. First, the acquisition pattern generation unit 111 acquires set information of a prediction model from the management terminal 400 (step S501). Specifically, for example, the acquisition pattern generation unit 111 may display, on the management terminal 400, an input screen for receiving input of items to be designated as an objective variable and an explanatory variable, and acquire set information of a prediction model by receiving input to the input screen by a manager. The acquisition pattern generation unit 111 generates an acquisition pattern, based on the acquired set information of the prediction model (step S502). In this instance, a value designated as each item of the acquisition pattern is, for example, a value input by a manager via the input screen for receiving input of values designated as a content ID, a day of the week, a time period, a place, a sex, an age group, an acquisition number, and a rule. The acquisition pattern generation unit 111 stores, in the acquisition pattern storage unit 112, the acquired set information of the prediction model, and the generated acquisition pattern.

The output schedule control unit 113 reads the acquisition pattern from the acquisition pattern storage unit 112, and generates a schedule relevant to each acquisition pattern (step S503). The output schedule control unit 113 stores the generated output schedule in the output schedule storage unit 114.

Next, processing of outputting a content, based on the output schedule is described.

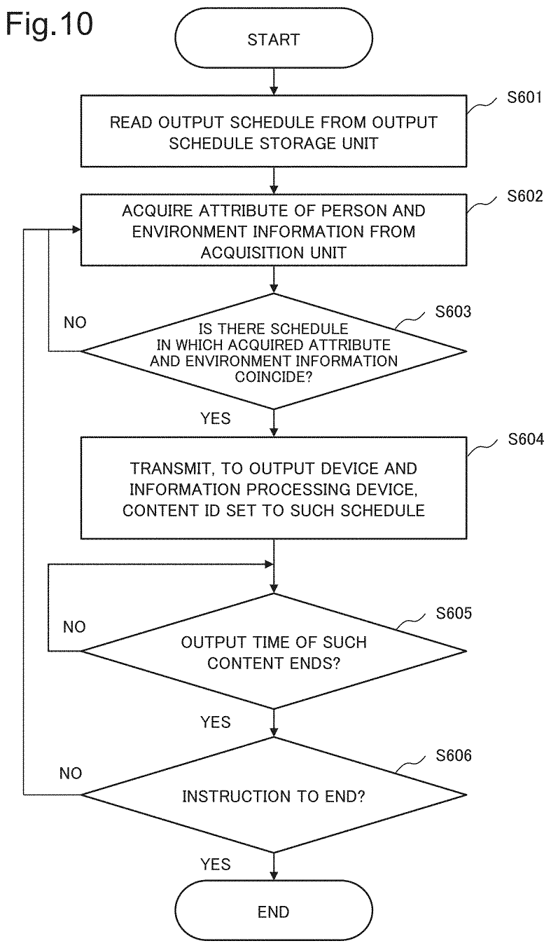

When a plurality of imaging devices 200 and a plurality of output devices 300 exist, processing of outputting a content, based on the output schedule, and processing of generating viewing data relating to a person viewing the content are performed for each piece of imaging data in an imaging range relevant to each of the output devices 300. Note that, in the following description, it is assumed that the contents control device 100 acquires imaging data from one imaging device 200 that images an imaging range relevant to a particular output device 300. FIG. 10 is a flowchart illustrating an operation of the contents selection unit 130. The contents selection unit 130 starts an operation depending on a timing of storing the output schedule in the output schedule storage unit 114 or a timing of updating the output schedule, but is not limited to this example. For example, the contents selection unit 130 may start an operation when a preset set time arrives, or may start an operation according to an instruction from the management terminal 400.

The data acquisition unit 131 reads the output schedule from the output schedule storage unit 114 (step S601). Moreover, the data acquisition unit 131 acquires measurement data and environment information from the acquisition unit 120 (step S602). The condition determination unit 132 determines whether there is, in the output schedule, a schedule in which a value designated as each item of a “condition” coincides with an attribute of a person and environment information included in the measurement data acquired by the data acquisition unit 131 (step S603). When there is a coincident schedule as a result of the determination (step S603; YES), the condition determination unit 132 transmits information about the coincident schedule to the contents notification unit 133. In this instance, when there are a plurality of schedules coinciding with the “condition”, the condition determination unit 132 selects information about a schedule to be transmitted to the contents notification unit 133 according to a “rule” set to a schedule. When receiving the information about the schedule from the condition determination unit 132, the contents notification unit 133 transmits a content ID to be set to “output” of the schedule, to the output device 300 and the information processing device 500 (step S604).

Hereinafter, description is given with reference to the set information of the prediction model illustrated in FIG. 4, the acquisition pattern illustrated in FIG. 5, and the output schedule illustrated in FIG. 6. For example, the data acquisition unit 131 acquires information in which environment information includes {Monday}, {10:00}, and {place 1}, and attributes are {female} and {20 to 29}, and information in which environment information is the same, and attributes are {female} and {40 to 49}. The condition determination unit 132 searches the output schedule illustrated in FIG. 6 for a schedule in which these pieces of acquired information coincide with the value designated as the “condition”. Accordingly, the acquired information coincides with the conditions of the schedules 1 and 3. Herein, since the “rule” is set to prioritizing the schedule 1, the condition determination unit 132 reports to the contents notification unit 133 that the schedule 1 coincides with the condition. The contents notification unit 133 transmits a content ID “0001” set to the schedule 1 to the output device 300 and the information processing device 500.

When there is no schedule coinciding with the value designated as the “condition” (step S603; NO), the contents selection unit 130 returns to the processing (S602) of acquiring an attribute of a person, and environment information from the acquisition unit 120.

When receiving the content ID by the processing in S604, the output device 300 reads, from the contents storage unit 310, a content relevant to the content ID, and outputs the read content. When an output time of the content ends (S605; YES), and a predetermined end instruction is not notified (S606; NO), the contents selection unit 130 returns to the processing (S602) of acquiring an attribute of a person, and environment information from the acquisition unit 120. Herein, the notification of a predetermined end instruction may be given from a management terminal or other non-illustrated connection equipment, or may be set in such a way as to be given to the contents control device 100 at a predetermined timing. When the predetermined end instruction is notified, processing of the contents selection unit 130 is ended (step S606).

Next, processing of generating viewing data relating to a person viewing a content in the information processing device 500 is described.

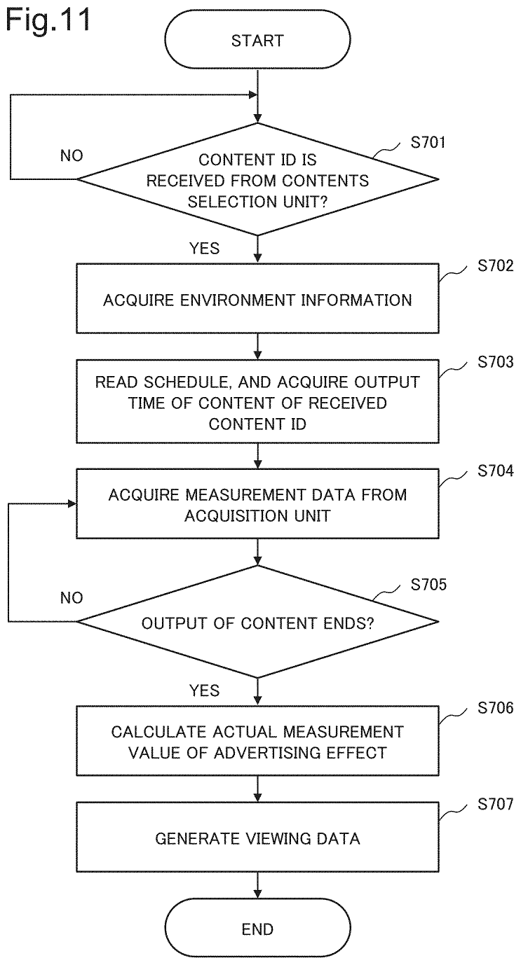

FIG. 11 is a flowchart illustrating an operation of the viewing data generation unit 510. When receiving the content ID from the contents notification unit 133 (S701; YES), the data acquisition unit 511 acquires the environment information from the acquisition unit 120 (S702). Moreover, the data acquisition unit 511 reads the schedule from the output schedule storage unit 114, and acquires an output time of the content. For example, when acquiring the content ID “0001”, the data acquisition unit 511 acquires the environment information relating to the output device 300 that outputs a content of the content ID “0001”, and an output time “5 minutes” of the content of the content ID “0001”. Note that an order of performing the processing in S702 and S703 is not limited to this example, and the processing in S702 may be performed after the processing in S703 is performed, or the processing in S702 and S703 may be performed in parallel to each other.

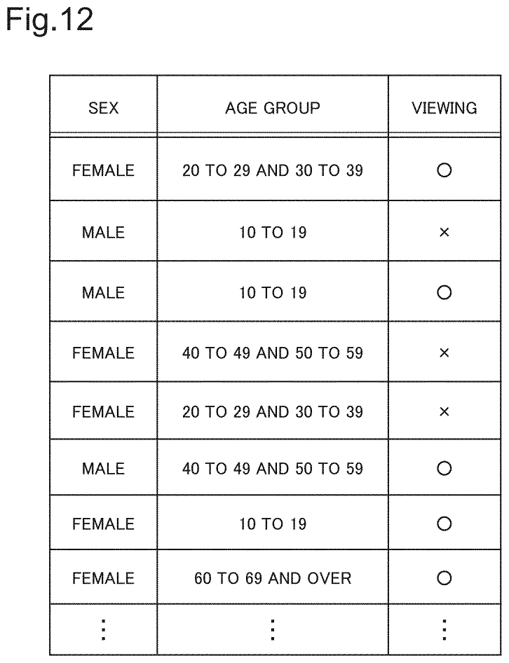

Furthermore, when a content of the received content ID is output from the output device 300, the data acquisition unit 511 acquires the measurement data from the acquisition unit 120 (S704). The data acquisition unit 511 continues the processing in S704 until the output of the content ends. For example, the data acquisition unit 511 acquires, from the acquisition unit 120, the measurement data for 5 minutes in which the content of the content ID “0001” are output, from a time when the condition determination unit 132 determines that a “condition” coincides. FIG. 12 is a diagram illustrating one example of the measurement data acquired from the acquisition unit 120 by the data acquisition unit 511. In the example of FIG. 12, the data acquisition unit 511 acquires information being a “sex”, an “age group”, and “viewing” of a person detected by the attribute extraction unit 122 in the acquisition unit 120. The “viewing” is information indicating whether a person has a viewed content. Herein, the attribute extraction unit 122 may determine whether a person has a viewed content, by extracting a face of the person or a direction of a gaze. For example, the attribute extraction unit 122 extracts a face of a person or a direction of a gaze, and measures a time in which the face or the gaze is directed to the output device 300. Then, when the face or the gaze is directed to the output device 300 for a predetermined time, the attribute extraction unit 122 may determine that the person who has directed the face or the gaze have viewed the content. Note that a method of determining whether a person has a viewed content is not limited to this example. For example, another method may be used as a determination method, such as a method of detecting a walking speed of a person, and determining that a person whose walking speed decreases at a predetermined rate or more has a viewed content.

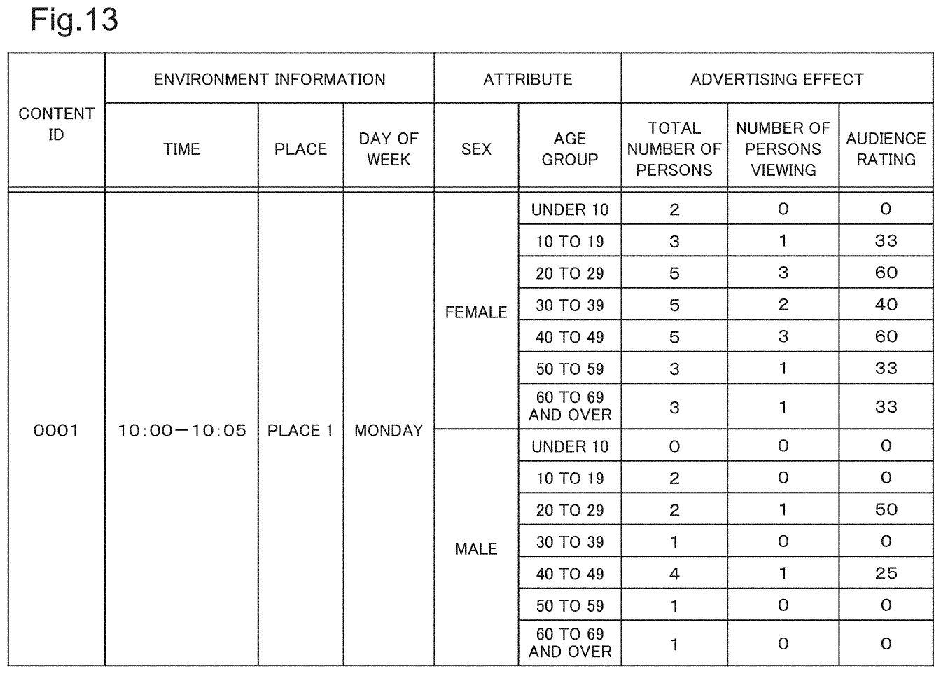

When the output of the content of the content ID received in S604 ends (S705; YES), the advertising effect calculation unit 512 calculates an actual measurement value of an advertising effect, based on the information acquired by the data acquisition unit 511 (S706). For example, the advertising effect calculation unit 512 calculates, for each sex and age group, the number of imaged persons, the number of persons who have viewed a content, a ratio of the number of persons who have viewed a content among the number of imaged persons, and the like. The data control unit 513 associates the information acquired by the data acquisition unit 511 with the actual measurement value of the advertising effect calculated by the advertising effect calculation unit 512 (S707). FIG. 13 is a diagram illustrating one example of viewing data. The example of FIG. 13 illustrates an attribute of a person located in an imaging range when a content of the content ID “0001” are output at a time of {10:00 to 10:05} in {place 1} on {Monday}, and an actual measurement value of an advertising effect for each person having each attribute. For example, in the environment, the number of persons who have a viewed content among the total number “5” of persons having attributes {female} and {20 to 29} is “3”, and an audience rating is “60”%. The data control unit 513 stores, in the viewing data storage unit 514, associated data, i.e., viewing data, for each acquisition pattern.

Next, processing of changing the output schedule, based on the number of pieces of the generated viewing data is described.

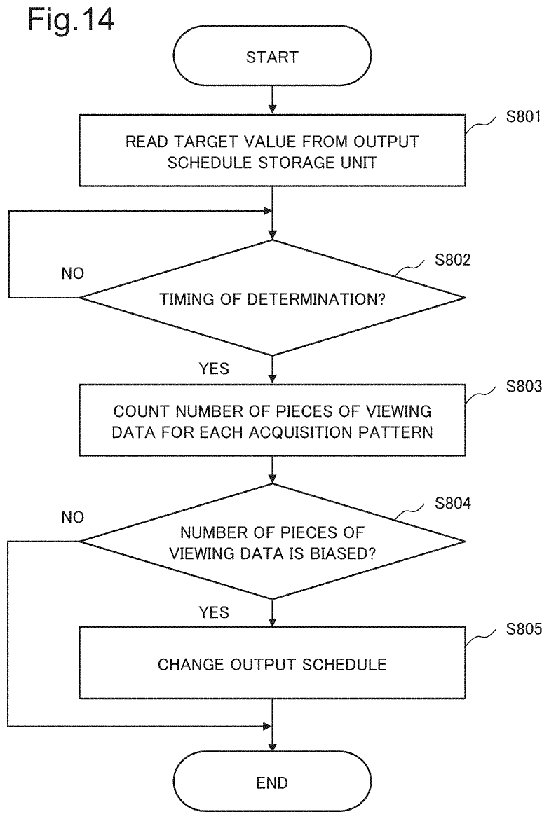

FIG. 14 is a diagram illustrating one example of operations of the determination unit 520 and the schedule change unit 530. The data acquisition unit 521 reads, from the output schedule storage unit 114, a target value set to each schedule (S801). In the example of FIG. 14, the data acquisition unit 521 reads a target value “100” designated in each schedule. When a predetermined timing arrives (S802; YES), the data acquisition unit 521 counts the number of pieces of the generated viewing data for each acquisition pattern (S803). Herein, the predetermined timing may be any timing. For example, the predetermined timing may be a preset time or an end point of predetermined processing of the contents control device 100, or may be a point where an instruction is received from the management terminal 400 or non-illustrated connection equipment.

The change determination unit 522 determines, based on the target value, whether the number of pieces of the viewing data is biased (S804). A situation where the number of pieces of the viewing data is biased is, but not limited to, for example, a situation where the number of pieces of the viewing data in the acquisition pattern 1 reaches the target value, whereas the number of pieces of the viewing data in the acquisition pattern 3 does not reach the target value. For example, the change determination unit 522 may determine that the number of pieces of the viewing data is biased in a situation where the numbers of pieces of the viewing data in both of the acquisition patterns 1 and 3 do not reach the target value, and an absolute value of a difference between the numbers of pieces of the viewing data in both of the acquisition patterns is equal to or more than a predetermined threshold value. The change determination unit 522 determines whether to change the output schedule, by determining whether the number of pieces of the viewing data is biased.

When it is determined, as a result of the determination by the change determination unit 522, that the number of pieces of the viewing data is biased, i.e., the output schedule is to be changed (S804; YES), the schedule change unit 530 changes the output schedule. The schedule change unit 530 may change a schedule in such a way as to prioritize acquisition of the viewing data relevant to an acquisition pattern in which the number of pieces of the viewing data does not reach a target value. For example, it is assumed that, for a target value “100”, the number of pieces of the viewing data in the acquisition pattern 1 is “100”, and the number of pieces of the viewing data in the acquisition pattern 3 is “50”. In this instance, since the number of pieces of the viewing data in the acquisition pattern 3 does not reach the target value, the output schedule is changed in such a way as to prioritize output based on the schedule 3 relevant to the acquisition pattern 3.

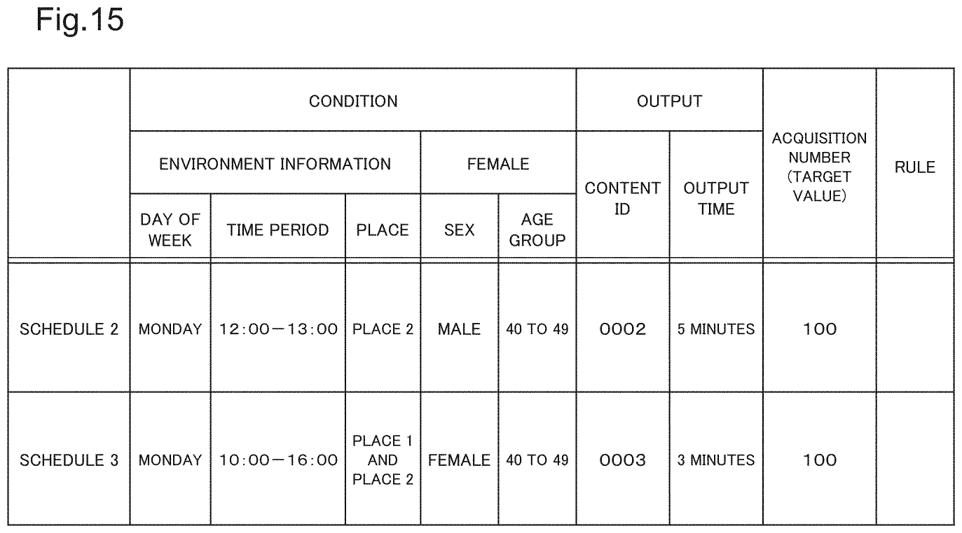

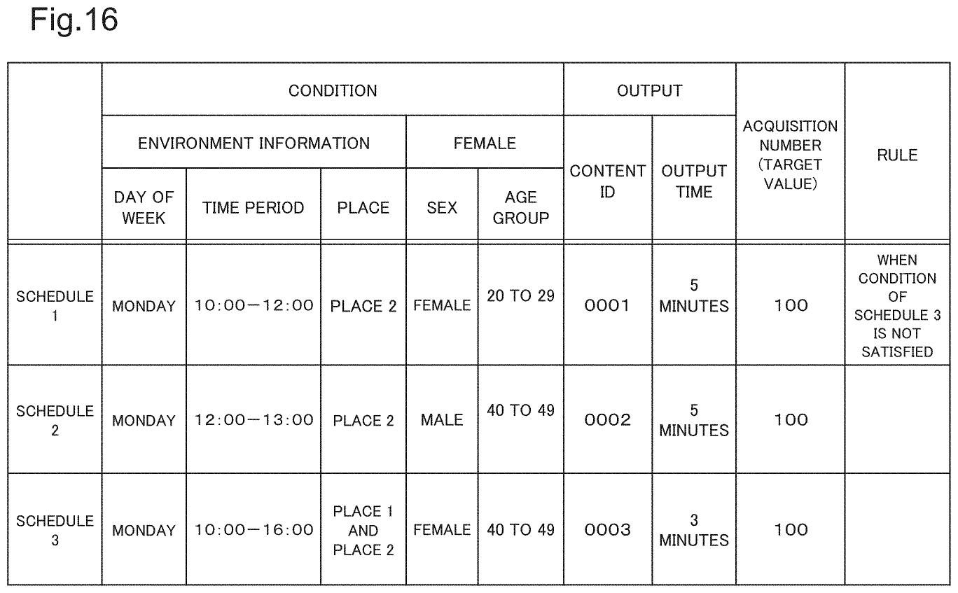

FIGS. 15 and 16 are diagrams each illustrating one example of the changed output schedule. The example of FIG. 15 illustrates that output of the schedule 3 is prioritized by deleting the schedule 1, and deleting the “rule” of the schedule 3. Moreover, the example of FIG. 16 illustrates that the “rule” of the schedule 3 is deleted, and a “rule” specifying that the schedule 1 is output when the condition of the schedule 3 is not satisfied is added to the schedule 1. In this way, acquisition of desired viewing data can be prioritized by changing a rule, i.e., a priority degree between schedules, based on a result of determination by the determination unit 520.

Next, processing of generating a prediction model, based on the viewing data is described.

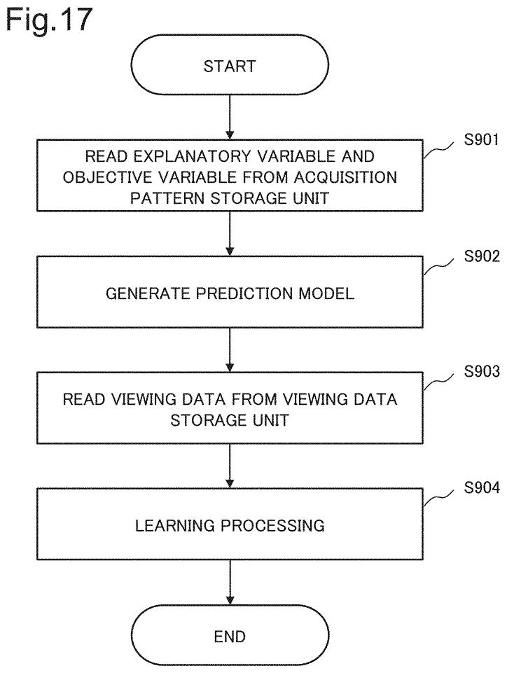

FIG. 17 is a diagram illustrating one example of an operation of the analysis unit 140. The prediction model generation unit 141 reads, from the acquisition pattern storage unit 112, the set information of the prediction model, i.e., the objective variable and the explanatory variable (S901). Moreover, the prediction model generation unit 141 generates a prediction model by use of the set information of the prediction model and the viewing data (S902). When the objective variable and the explanatory variable illustrated in FIG. 4 are read, the prediction model generation unit 141 generates a prediction model in which {audience rating} is designated as the objective variable, and {place}, {time period}, {day of the week}, {sex}, {age group}, and {content identification (ID)} are the explanatory variables. The prediction model is represented, for example, as in Eqn. 1 below. αn (n is an integer of 0 to N, and N is the number of the explanatory variable) in Eqn. 1 is a parameter representing a relation between the objective variable and the explanatory variable.

{audience rating}=α0+α1×{place 1}+α2×{Monday}+α3×{10:00 to 12:00}+α4×{female}+α5×{20 to 29}+α6×{0001}+ . . . [Eqn. 1]

Next, the prediction model generation unit 141 reads the viewing data from the viewing data storage unit 514 (S903). Then, the prediction model generation unit 141 learns the prediction model in Eqn. 1 by use of the read viewing data as training data, and determines a value of a parameter (S904). In this instance, when using, as the training data, viewing data in which a sex is {female}, the prediction model generation unit 141 may learn by substituting “1” for {female}, and substituting “0” for {male}. Moreover, when a value of an item indicates a numerical value, the prediction model generation unit 141 may substitute the numerical value of the item for an explanatory variable to relevant to the item, and learn. A learning method used herein is, but not limited to, for example, a regression analysis, and various schemes of determining a value of a parameter are conceivable. The prediction model generation unit 141 stores, in the prediction model storage unit 142, a prediction model for which a value of a parameter is determined.

As described above, the contents control device 100 according to the first example embodiment generates an output schedule according to an acquisition pattern of viewing data, and generates viewing data of a content output according to the generated output schedule. Then, when the number of pieces of viewing data is biased, the contents control device 100 changes the output schedule in such a way as to output preferentially a schedule relevant to an acquisition pattern of viewing data of which the number of pieces of viewing data is small. Then, the viewing data of which the number of pieces of viewing data is small can be collected preferentially by outputting a content according to the changed output schedule. Therefore, bias of viewing data can be reduced. In other words, the contents control device 100 according to the first example embodiment can provide an advantageous effect that desired data to be used for selection of an appropriate content can be collected.

Furthermore, the information processing device 500 according to the first example embodiment changes an output schedule in such a way as to prioritize, among generated viewing data, an individual output schedule relevant to viewing data determined that the number of pieces of the generated viewing data does not satisfy a first target value. Thereby, the information processing device 500 can provide an advantageous effect of collecting preferentially viewing data determined that the number of pieces of the viewing data does not satisfy the first target value, i.e., desired data used for selection of an appropriate content can be collected.

Furthermore, the information processing device 500 according to the first example embodiment generates viewing data relevant to an individual output schedule in which a condition of outputting a content is satisfied. Thereby, viewing data including an attribute of a person and environment information designated by the condition can be generated. Therefore, desired data on a manager can be collected.

Furthermore, the information processing device 500 according to the first example embodiment can dispense with a manual change of a schedule of outputting a content. Therefore, desired data to be used for selection of an appropriate content can be efficiently collected.

Furthermore, the information processing device 500 according to the first example embodiment can efficiently collect viewing data relevant to each acquisition pattern to a target value. Therefore, accuracy of a prediction model to be generated by use of viewing data can be efficiently increased.

### Second Example Embodiment

A second example embodiment describes an example in which a contents control system determines whether to change an output schedule, depending on accuracy of a prediction model. A configuration of the contents control system according to the present example embodiment is similar to the configuration of the contents control system described with reference to FIG. 3 according to the first example embodiment, except for a determination unit. Hereinafter, description is omitted with regard to contents in which a configuration and an operation of the contents control system according to the present example embodiment overlap the description according to the first example embodiment.

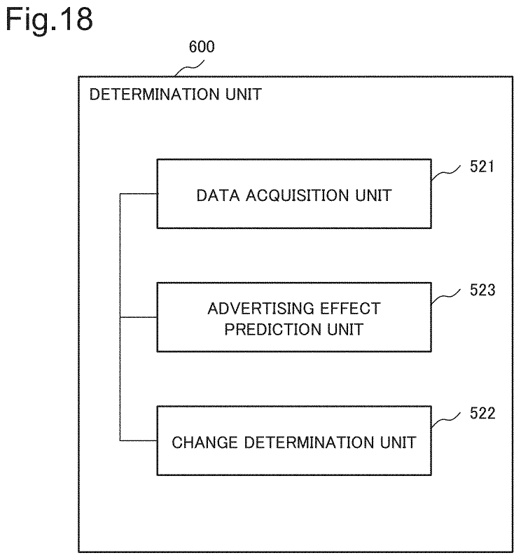

FIG. 18 is a block diagram illustrating one example of a configuration of a determination unit 600 according to the present example embodiment. In this instance, the determination unit 600 further includes an advertising effect prediction unit 523 in the configuration of the determination unit 520 illustrated in FIG. 8. The advertising effect prediction unit 523 calculates a prediction value of an advertising effect by use of generated viewing data and a prediction model. Hereinafter, in the present description, a prediction value of an advertising effect is also simply referred to as a “prediction value”.

Next, operations of the determination unit 600 and the schedule change unit 530 according to the present example embodiment are described.

The schedule change unit 530 determines whether to change an output schedule, depending on accuracy of a prediction model.

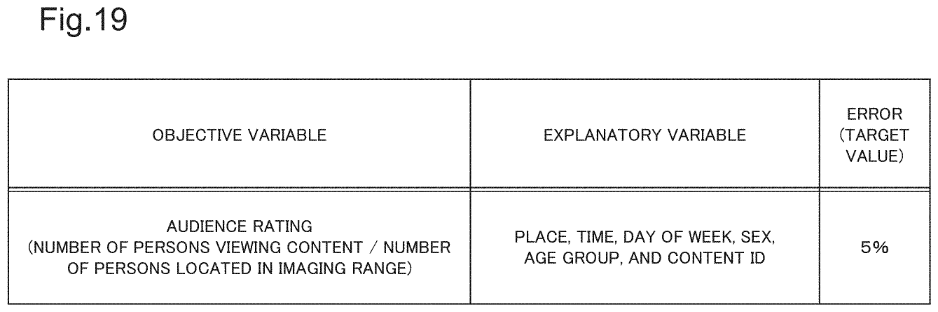

Herein, according to the present example embodiment, in processing of generating an output schedule, an acquisition pattern generation unit 111 receives, from a management terminal 400, a predetermined target value relating to accuracy of a prediction model, herein, input of a permitted error, together with each of items designated as an objective variable and an explanatory variable. FIG. 19 is a diagram illustrating one example of set information of a prediction model including a target value (also referred to as a “second target value”) relating to accuracy of a prediction model. An “error” illustrated in FIG. 19 indicates a target value relating to accuracy of a prediction model. In this example, an “error” indicates a ratio permitted as an error between a prediction value of an objective variable acquired by use of a prediction model, and an actual measurement value of an objective variable included in viewing data. In the example of FIG. 19, the target value is set to “5%”.

FIG. 20 is a diagram illustrating one example of operations of the determination unit 600 and the schedule change unit 530 when whether to change an output schedule is determined depending on accuracy of a prediction model, according to the present example embodiment. Note that a viewing data storage unit 514 stores viewing data one example of which is data illustrated in FIG. 13 described according to the first example embodiment. Moreover, a prediction model storage unit 142 stores a prediction model one example of which is the equation indicated by Eqn. 1 described according to the first example embodiment.

A data acquisition unit 521 reads a target value from an acquisition pattern storage unit 112 (S1001). In the example of FIG. 19, the acquisition pattern storage unit 112 reads a target value “5%”. When a predetermined timing arrives (S1002; YES), the data acquisition unit 521 reads viewing data from the viewing data storage unit 514 (S1003). Moreover, the data acquisition unit 521 reads a prediction model from the prediction model storage unit 142 (S1004). Herein, the predetermined timing may be any timing, as in S802 according to the first example embodiment.

Next, the advertising effect prediction unit 523 calculates a prediction value of an advertising effect, based on the prediction model and the viewing data read by the data acquisition unit 521 (S1005). Specifically, the advertising effect prediction unit 523 calculates a prediction value by substituting a predetermined value for an explanatory variable of the prediction model relevant to a value of each item. In this instance, when calculating a prediction value by use of viewing data holding a set of explanatory variables in which a sex is {female}, the advertising effect prediction unit 523 may substitute “1” for {female}, and substitute “0” for {male}. Moreover, when the value of the item indicates a numerical value, the advertising effect prediction unit 523 may substitute the numerical value of the item for an explanatory variable relevant to the item.

A change determination unit 522 compares the prediction value of the advertising effect with an actual measurement value of an advertising effect included in the viewing data. For example, the change determination unit 522 calculates a difference between the prediction value calculated by the advertising effect prediction unit 523 and the actual measurement value included in the viewing data. Then, the change determination unit 522 determines whether to change the output schedule, by calculating a ratio of an absolute value of the calculated difference to the prediction value, and determining whether the calculated ratio is equal to or less than the target value. Herein, the actual measurement value used for determination may be, but not limited to, a value of an advertising effect included in any viewing data holding a set of explanatory variables used for calculation of the prediction value. For example, the actual measurement value used for determination may be an average value, a median, or a mode of values of an advertising effect in the set of explanatory variables used for calculation of the prediction value, among a plurality of pieces of viewing data.

In S1006, for example, when the prediction value is “50”, and the actual measurement value is “60”, an absolute value of a difference becomes “10”. Herein, a ratio of the absolute value of the difference to the prediction value is “20%”. This ratio is over the target value of “5%”. Therefore, the change determination unit 522 determines that a condition is not satisfied, and then determines to change the output schedule.

When it is determined, as a result of the determination by the change determination unit 522, that the output schedule is to be changed, i.e., the ratio of the absolute value of the difference between the actual measurement value and the prediction value to the prediction value is over the target value (S1006; NO), the schedule change unit 530 changes the output schedule in such a way as to increase the number of pieces of the viewing data (S1007). For example, the schedule change unit 530 changes the target value of each acquisition number of pieces of the viewing data illustrated in FIG. 6 from “100” to “200”. When it is determined, as a result of the determination by the change determination unit 522, that the output schedule is to be changed, i.e., the ratio of the absolute value of the difference between the actual measurement value and the prediction value to the prediction value is equal to or less than the target value (S1006; YES), the processing of the schedule change unit 530 is ended.

As described above, when determining that accuracy of a prediction model does not satisfy a target value, an information processing device 500 according to the second example embodiment changes an output schedule in such a way as to increase the number of pieces of viewing data. Thereby, the number of pieces of viewing data for enhancing accuracy of a prediction model can be adjusted without acquiring labor. In other words, an advantageous effect that desired data to be used for selection of an appropriate content can be efficiently collected can be provided.

Furthermore, the operation described above may be performed together with the operation according to the first example embodiment. Thereby, the contents control device 100 according to the second example embodiment can more efficiently collect viewing data for enhancing accuracy of a prediction model.

### Third Example Embodiment

FIG. 21 is a block diagram illustrating a minimum configuration of an information processing device 700 according to a third example embodiment of the present disclosure. As illustrated in FIG. 21, the information processing device 700 includes a viewing data generation unit 710, a determination unit 720, and a schedule change unit 730. A configuration of the viewing data generation unit 710 is similar to the configuration of the viewing data generation unit 510 according to the first example embodiment. A configuration of the determination unit 720 is similar to the configuration of the determination unit 520 according to the first example embodiment. Moreover, the schedule change unit 730 is similar to the schedule change unit 530 according to the first example embodiment. Thus, detailed description thereof is omitted.

The viewing data generation unit 710 generates viewing data relating to viewing of a content output according to an output schedule.

The determination unit 720 determines whether to change the output schedule, based on viewing data of which a predetermined value relating to the generated viewing data does not satisfy a predetermined target value.

The schedule change unit 730 changes the output schedule, based on a result of the determination, in such a way that the predetermined value relating to the viewing data satisfies the predetermined target value.

Next, an operation of the information processing device 700 is described. FIG. 22 is a flowchart illustrating the operation of the information processing device 700 according to the present example embodiment.

The viewing data generation unit 710 generates viewing data relating to viewing of a content output according to an output schedule (S1101).

The determination unit 720 determines whether to change the output schedule, based on viewing data of which a predetermined value relating to the viewing data generated by the viewing data generation unit 710 does not satisfy a predetermined target value. When it is determined, as a result of the determination, that the output schedule is not to be changed (S1102; NO), the information processing device 700 ends the operation.

When the output schedule is to be changed as a result of the determination by the determination unit 720 (S1102; YES), the schedule change unit 730 changes the output schedule in such a way that the predetermined value relating to the viewing data satisfies the predetermined target value.

As described above, the information processing device 700 according to the present example embodiment can change an output schedule of a content relating to viewing data in such a way that a predetermined value relating to the viewing data satisfies a predetermined target value, and generate viewing data relating to viewing of a content to be output according to the changed output schedule. Thereby, the information processing device 700 can generate viewing data in such a way as to satisfy the predetermined target value. Therefore, an advantageous effect that desired data to be used for selection of an appropriate content can be collected can be provided.

The present disclosure has been described above with reference to the above-described example embodiments. However, the present disclosure is not limited to the above-described example embodiments. In other words, various aspects that can be understood by a person skilled in the art, such as many combinations or selection of the various disclosed elements described above, are applicable to the present disclosure within the scope of the present disclosure.

Further, it is noted that the inventor's intent is to retain all equivalents of the claimed invention even if the claims are amended during prosecution.

### REFERENCE SIGNS LIST

10 Computer
11 Processor
12 RAM
13 ROM
14 Storage device
15 Input/output interface
16 Bus
17 Drive device
18 Program
19 Peripheral equipment
20 Recording medium
100 Contents control device
110 Schedule generation unit
111 Acquisition pattern generation unit
112 Acquisition pattern storage unit
113 Output schedule control unit
114 Output schedule storage unit
120 Acquisition unit
121 Imaging data acquisition unit
122 Attribute extraction unit
123 Environment information acquisition unit
130 Contents selection unit
131, 511, 521 Data acquisition unit
132 Condition determination unit
133 Contents notification unit
140 Analysis unit
141 Prediction model generation unit
142 Prediction model storage unit
200 Imaging device
300 Output device
310 Contents storage unit
400 Management terminal
500, 700 Information processing device
510, 710 Viewing data generation unit
512 Advertising effect calculation unit
513 Data control unit
514 Viewing data storage unit
520, 720 Determination unit
522 Change determination unit
530, 730 Schedule change unit

1. An information processing device comprising:
at least one memory storing a set of instructions; and
at least one processor configured to execute the instructions to:
generate viewing data relating to viewing of a content to be output according to an output schedule;
determine whether to change the output schedule, based on the viewing data of which a predetermined value relating to the generated viewing data does not satisfy a predetermined target value; and
change the output schedule, based on a result of the determination, in such a way that a predetermined value relating to the viewing data satisfies the predetermined target value.

2. The information processing device according to claim 1, wherein
the output schedule includes a plurality of individual output schedules each associated with each of the contents, and
the processor is further configured to execute the instructions to:
generate the viewing data relevant to each of the plurality of individual output schedules, and
change the output schedule in such a way that a number of pieces of the viewing data to be generated is changed.

3. The information processing device according to claim 2, wherein the processor is further configured to execute the instructions to:
change the output schedule in such a way as to prioritize the individual output schedule relevant to the viewing data of which a number of pieces of generated viewing data does not satisfy a first target value among the viewing data, over the individual output schedule relevant to viewing data of which a number of pieces of generated viewing data satisfies the first target value.

4. The information processing device according to claim 2, wherein the processor is further configured to execute the instructions to:
change the output schedule in such a way that a number of pieces of the viewing data to be generated increases, when accuracy of a prediction model to be generated based on the viewing data does not satisfy a second target value.

5. The information processing device according to claim 4, wherein
the prediction model is a model that calculates a prediction value of an advertising effect of the content, and
the processor is further configured to execute the instructions to:
generate the viewing data associating information relating to a person viewing the content with an actual measurement value of an advertising effect of the content being calculated based on information relating to the person, and
determine to change the output schedule, based on the prediction value and the actual measurement value, when accuracy of the prediction model does not satisfy the second target value.

6. The information processing device according to claim 2, wherein
the individual output schedule includes a condition of outputting the associated content, and
the processor is further configured to execute the instructions to:
generate the viewing data relevant to an individual output schedule satisfying the condition.

7. The information processing device according to claim 2, wherein
the individual output schedule includes information indicating a priority degree of each individual output schedule, and
the processor is further configured to execute the instructions to:
change a priority degree between the plurality of individual output schedules, based on a result of the determination.

8. The information processing device according to claim 1, wherein the processor is further configured to execute the instructions to:
generate an output schedule of a content, according to an acquisition pattern of designated viewing data; and
select, according to the output schedule, the content to be output.

9. An information processing method comprising:
generating viewing data relating to viewing of a content to be output according to an output schedule;
determining whether to change the output schedule, based on the viewing data of which a predetermined value relating to the generated viewing data does not satisfy a predetermined target value; and
changing the output schedule, based on a result of the determination, in such a way that a predetermined value relating to the viewing data satisfies the predetermined target value.

10. A recording medium storing a program that causes a computer to execute:
processing of generating viewing data relating to viewing of a content to be output according to an output schedule;
processing of determining whether to change the output schedule, based on the viewing data of which a predetermined value relating to the generated viewing data does not satisfy a predetermined target value; and
processing of changing the output schedule, based on a result of the determination, in such a way that a predetermined value relating to the viewing data satisfies the predetermined target value.
